(19) United States
(12) Patent Application Publication
(10) Pub. No.: US 2026/0294703 A1
(43) Pub. Date: Oct. 1, 2026

(54) AMBULANCE COVER FOR AN UNMANNED SURFACE VEHICLE AND METHOD OF ASSEMBLING THE SAME

(71) Applicant: HYDRONALIX, INC., Green Valley, AZ (US)

(72) Inventors: Anthony C. MULLIGAN, Tucson, AZ (US); Deborah E. ORR, Vail, AZ (US); Uneek A. ARMENTA, Tucson, AZ (US); Christina Marie POWELL, Boynton Beach, FL (US)

(21) Appl. No.: 19/630,123

(22) Filed: Mar. 26, 2026

Related U.S. Application Data
(60) Provisional application No. 63/778,373, filed on Mar. 26, 2025.
(60) Provisional application No. 63/786,898, filed on Apr. 10, 2025.

(51) Int. Cl. A61G 3/08; B63B 29/04; B63B 35/00

(52) U.S. Cl. CPC A61G 3/0875; B63B 29/04; B63B 35/00; B63B 2029/043; B63B 2035/004; B63B 2035/007

(57) ABSTRACT

An ambulance cover for an unmanned surface vehicle and a method of assembling the same are disclosed. An ambulance cover for an unmanned surface vehicle includes: a lid configured to be mounted on an unmanned surface vehicle; and a seat mountable on the lid, and the ambulance cover is configured to secure any of one or more stretchers at attachment points of the ambulance cover.

### CROSS-REFERENCE TO RELATED APPLICATIONS

This application claims priority to and the benefit of Provisional Application No. 63/778,373, filed on Mar. 26, 2025, and Provisional Application No. 63/786,898, filed on Apr. 10, 2025, in the United States Patent and Trademark Office, the entire contents of both of which are incorporated herein by reference.

### BACKGROUND

### 1. Field

Aspects of embodiments of the present disclosure relate to an ambulance cover for an unmanned surface vehicle and a method of assembling the same.

### 2. Description of the Related Art

In an event of an injured or wounded person, such as a soldier, it may be desired or necessary to transport the person over water. For example, it may be desired or necessary to transport the person from the shore to a medical ship. Further, it may be desired or necessary to perform medical care for the person during the transport.

### SUMMARY

The present application relates to embodiments of an ambulance cover for an unmanned surface vehicle and a method of assembling the same. According to an aspect of one or more embodiments of the present invention, an ambulance cover for an unmanned surface vehicle is configured to allow a person, such as a Medical Corpsman, to ride with an injured or wounded person, such as a wounded soldier from the shore or contested hostilities, to a location, such as a medical ship several miles away, and is autonomous such that the Medical Corpsman can focus on care of the patient.

According to one or more embodiments of the present disclosure, an ambulance cover for an unmanned surface vehicle (e.g., boat) includes: a lid configured to be mounted on an unmanned surface vehicle; and a seat mountable on the lid, wherein the ambulance cover is configured to secure any of one or more stretchers at attachment points of the ambulance cover.

In one or more embodiments, the unmanned surface vehicle is configured to operate autonomously.

In one or more embodiments, the one or more stretchers include any of a plurality of different stretchers.

In one or more embodiments, the ambulance cover further includes one or more watertight dry storage compartments.

In one or more embodiments, the one or more watertight dry storage compartments include a plurality of watertight dry storage compartments.

In one or more embodiments, the ambulance cover further includes at least one of a life vest, paddles, a blanket, a fire extinguisher, a whistle, and an air horn in the one or more watertight dry storage compartments.

In one or more embodiments, the ambulance cover further includes navigation lights.

In one or more embodiments, the ambulance cover further includes a patient hood.

In one or more embodiments, the ambulance cover further includes crane attachment slots.

In one or more embodiments, the ambulance cover further includes collapsible poles that are insertable through sleeves of the unmanned surface vehicle.

In one or more embodiments, the ambulance cover further includes carabiner clips to be secured to the unmanned surface vehicle.

According to one or more embodiments of the present disclosure, a method of assembling an ambulance cover for an unmanned surface vehicle includes: mounting a lid on an unmanned surface vehicle; mounting a seat on the lid; and securing a stretcher at attachment points of the ambulance cover.

In one or more embodiments, mounting the lid includes securing the lid with rubber straps.

In one or more embodiments, the method further includes securing the ambulance cover to the unmanned surface vehicle with carabiner clips.

In one or more embodiments, the method further includes releasing pontons of the ambulance cover.

In one or more embodiments, the method further includes inserting poles of the ambulance cover through sleeves of the unmanned surface vehicle.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable device.

### BRIEF DESCRIPTION OF THE DRAWINGS

The above and other aspects and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale.

FIG. 1A is a schematic view of an ambulance cover for an unmanned surface vehicle according to an embodiment of the present disclosure;

FIGS. 1B and 1C are schematic views of items to be contained in a dry bag of the ambulance cover for an unmanned surface vehicle according to an embodiment of the present disclosure;

FIGS. 2A to 2F are schematic views showing tasks of assembling an ambulance cover for an unmanned surface vehicle;

FIGS. 3A to 3K are schematic views showing tasks of assembling an ambulance cover for an unmanned surface vehicle;

FIGS. 4A to 4L are schematic views showing navigation lights and dry bags of an ambulance cover for an unmanned surface vehicle; and

FIG. 5 is a schematic view of an ambulance cover for an unmanned surface vehicle according to an embodiment of the present disclosure.

### DETAILED DESCRIPTION

The present disclosure relates to various embodiments of an ambulance cover for an unmanned surface vehicle and a method of assembling the same.

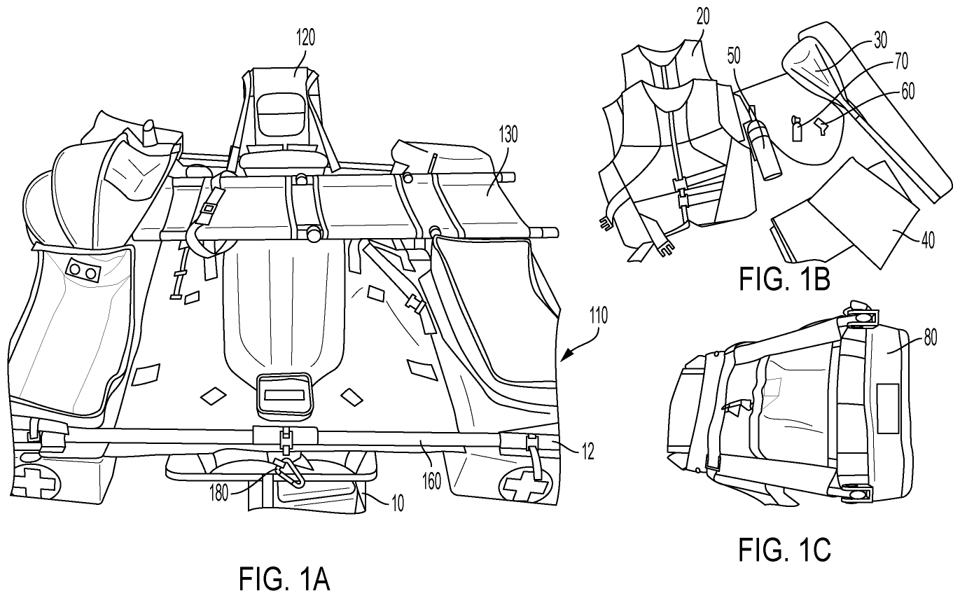

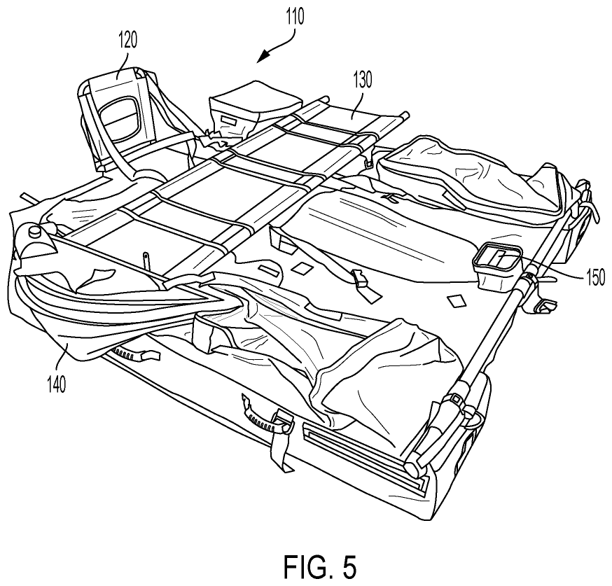

FIG. 1A and FIG. 5 are schematic views of an ambulance cover for an unmanned surface vehicle according to an embodiment of the present disclosure.

According to an embodiment of the present disclosure, an ambulance cover 100 for an unmanned surface vehicle includes: a lid 110 configured to be mounted on an unmanned surface vehicle 10; and a seat 120 mountable on the lid, and the ambulance cover is configured to secure any of one or more stretchers 130 at attachment points of the ambulance cover 100. The ambulance cover 100 may be configured to secure any of various stretchers, including but not limited to Talon, Reeves, Spine board, Raven, Stokes, and Skedco stretchers.

In an embodiment, the ambulance cover 100 for an unmanned surface vehicle may further include a patient hood (e.g., a collapsible patient hood) 140, for example, including a window and shade.

In an embodiment, the ambulance cover 100 for an unmanned surface vehicle may further include slots (e.g., four slots) 150 for crane attachment.

In an embodiment, the seat 120 is configured for a medic and includes a Velcro booster. The seat 120 may be positioned relative to the stretcher 130 so that the medic can easily treat the patient while the unmanned surface vehicle 10 moves to a desired destination, such as a medical ship.

In an embodiment, the ambulance cover 100 for an unmanned surface vehicle may further include two collapsible poles (e.g., carbon fiber poles) 160 configured to secure the ambulance cover 100 to the unmanned surface vehicle 10.

The ambulance cover 100 for an unmanned surface vehicle may further include navigation lights (e.g., two white headlights and/or red and green navigation lights) 400. In one or more embodiments, the navigation lights 400 may be USB chargeable, have a built-in battery, have a waterproof rate IPX5, and/or have an irradiation distance of 300 to 500 meters, but the present disclosure is not limited thereto.

FIGS. 1B and 1C are schematic views of items to be contained in a dry bag 500 of the ambulance cover for an unmanned surface vehicle according to an embodiment of the present disclosure.

In an embodiment, the ambulance cover 100 may include a plurality of watertight storage compartments (e.g., dry bags) 500, for example, five waterproof storage compartments. Items to be contained in the waterproof storage compartments may include life vests 20, paddles 30, an emergency blanket 40, a fire extinguisher 50, a whistle 60, an air horn 70, and a medic seat 80. However, a number of the waterproof storage compartments and the items contained therein are not limited thereto. In an embodiment, at least one of the watertight storage compartments is compatible with a Moves Patient Monitoring System.

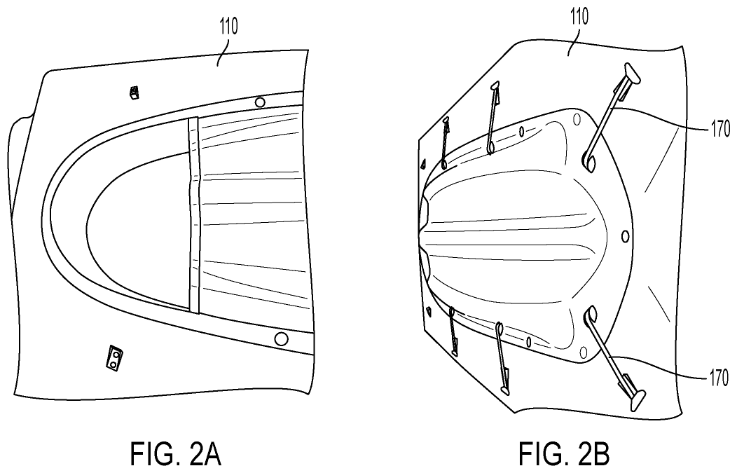

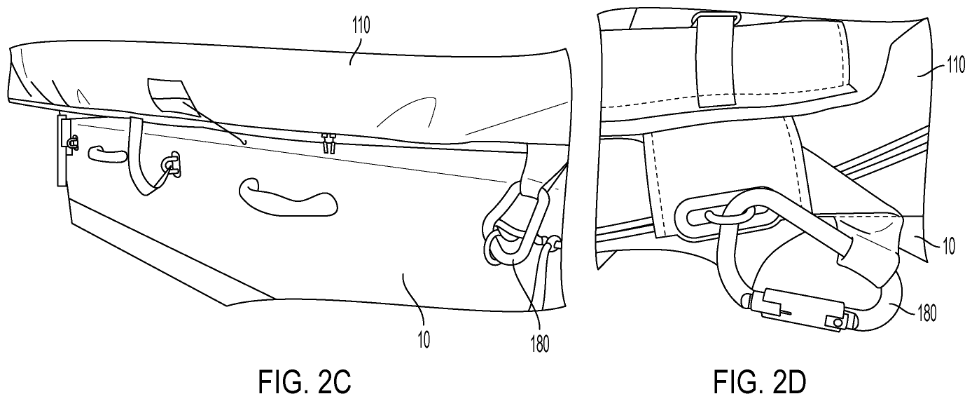

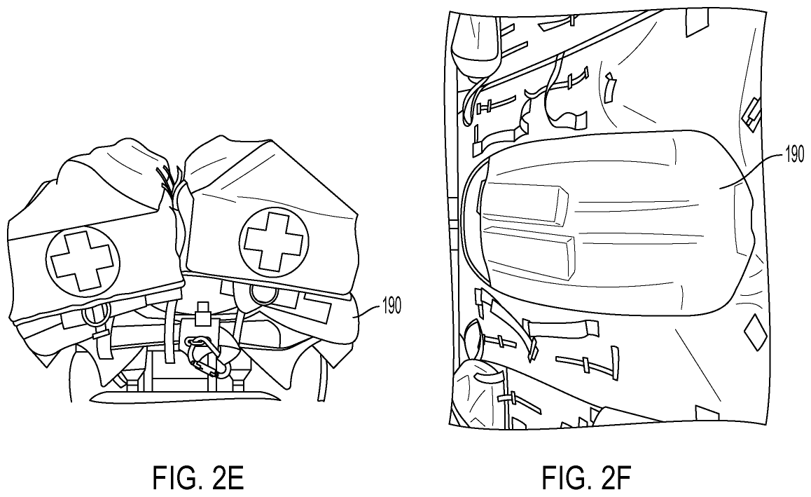

FIGS. 2A to 2F are schematic views showing tasks of assembling an ambulance cover for an unmanned surface vehicle.

As shown in FIGS. 2A and 2B, in an embodiment, the method includes a task of mounting the lid 110, such as with a foot well and securing the lid with rubber straps 170. As shown in FIGS. 2C and 2D, in an embodiment, the method further includes securing the ambulance cover 110 to the unmanned surface vehicle 10 with carabiner clips 180, such as on D-rings at a front and sides of the unmanned surface vehicle). As shown in FIGS. 2E and 2F, in an embodiment, the method further includes releasing pontons 190 of the ambulance cover 100, such as by unclipping the pontons 190.

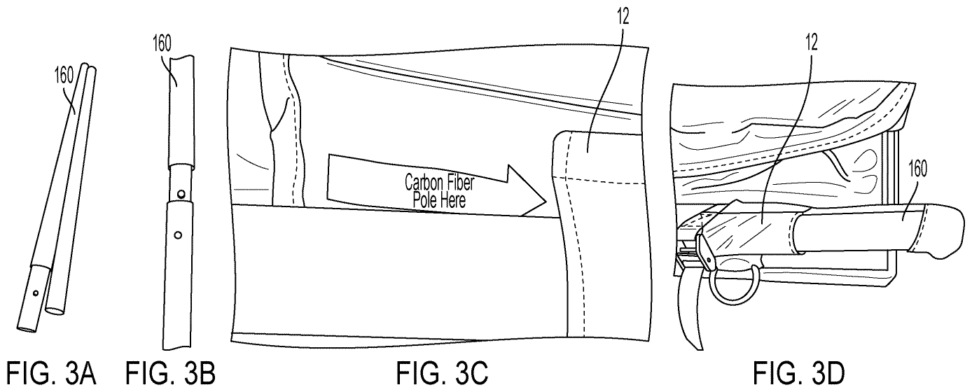

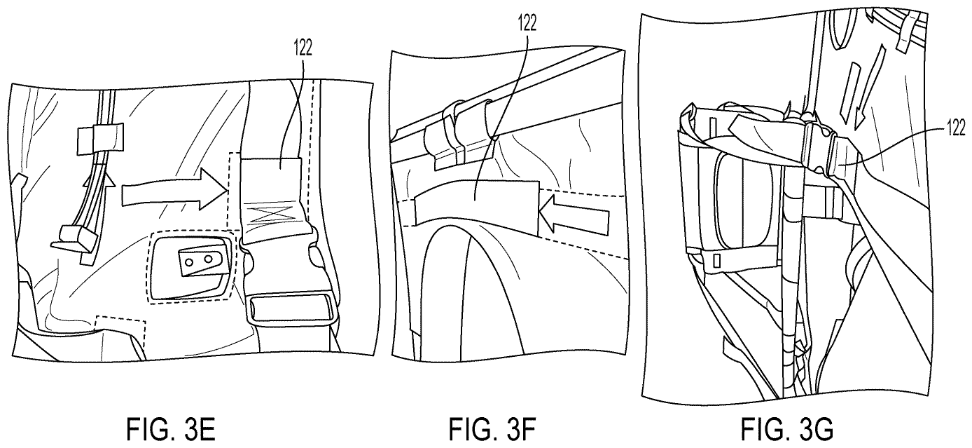

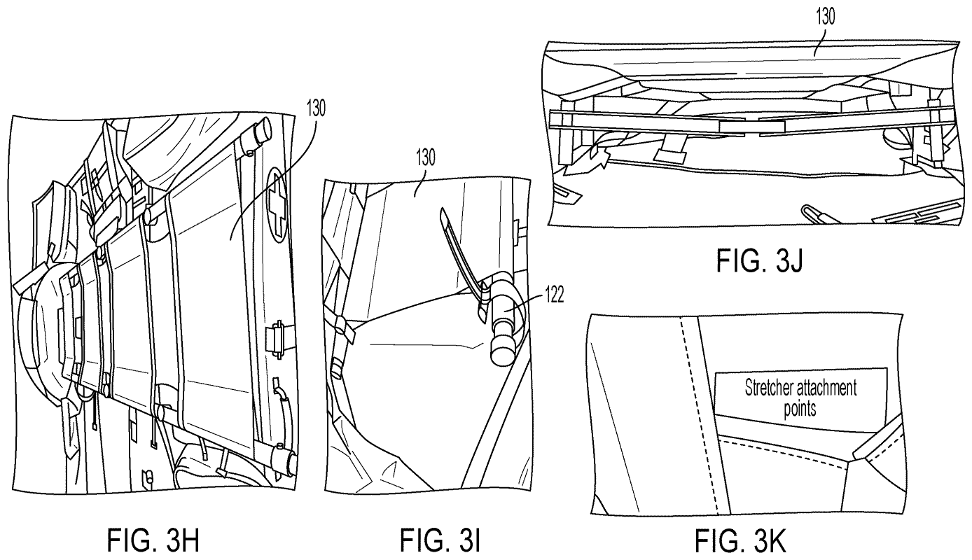

FIGS. 3A to 3K are schematic views showing tasks of assembling an ambulance cover for an unmanned surface vehicle.

As shown in FIGS. 3A to 3D, in an embodiment, the method further includes securing the ambulance cover 100 to the unmanned surface vehicle 10 with carabiner clips 180. As shown in FIGS. 3A to 3D, in an embodiment, the method further includes assembling and placing, or inserting, poles (e.g., collapsible poles) 160 through sleeves 12 on a front and back of the unmanned surface vehicle. For example, Velcro endcaps may be placed over the poles 160 and tightened via straps. As shown in FIGS. 3E to 3G, in an embodiment, the method further includes attaching the medic seat 120, such as via Velcro in the back and clipping in at labeled buckle points 122. As shown in FIGS. 3H to 3K, in an embodiment, the method further includes securing the stretcher 130 to labeled attachment points and tightening.

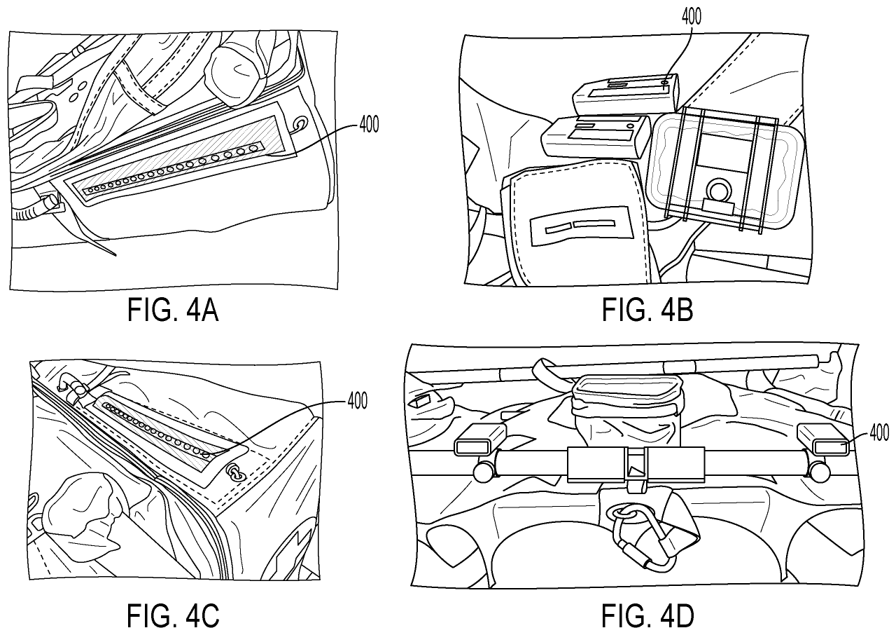

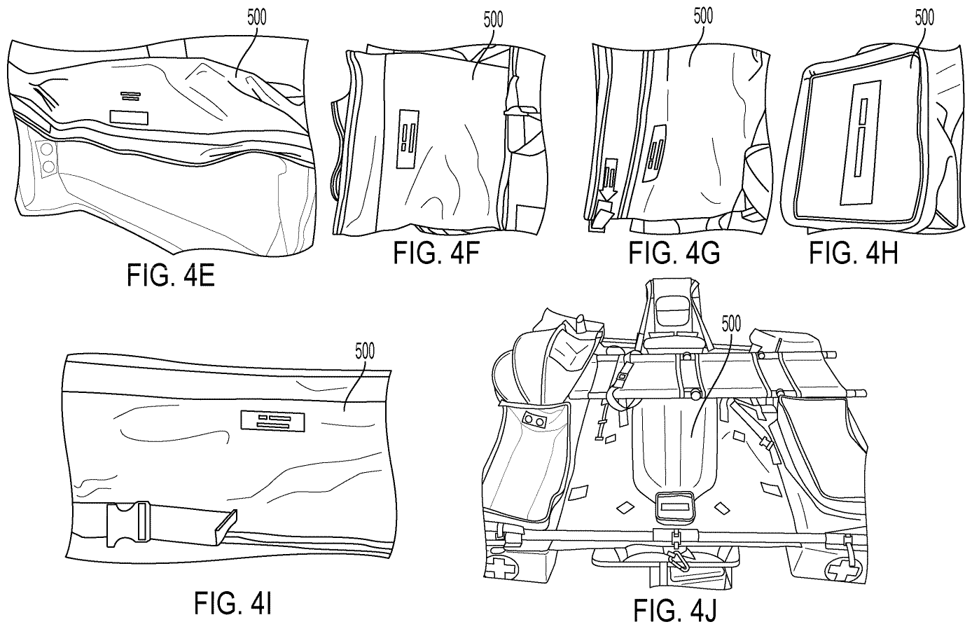

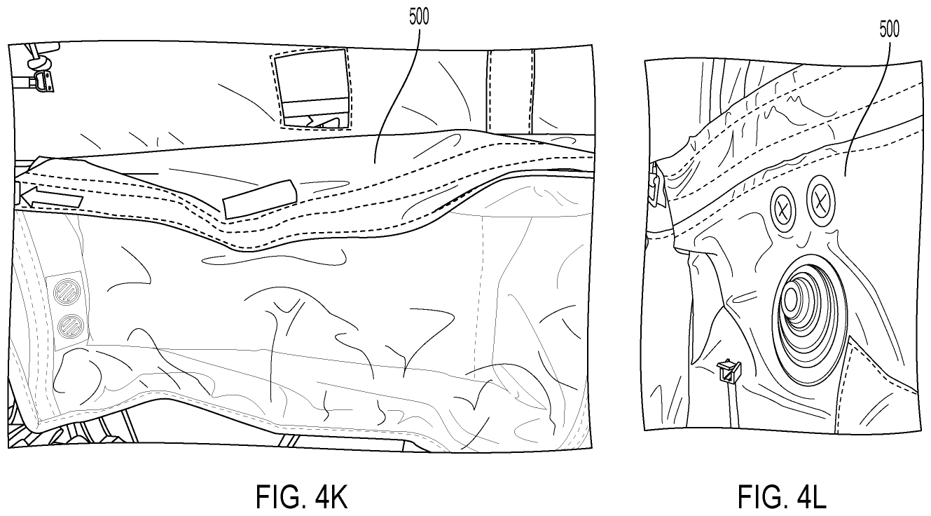

FIGS. 4A to 4L are schematic views showing navigation lights and dry bags of an ambulance cover for an unmanned surface vehicle.

As shown in FIGS. 4A to 4D, according to one or more embodiments, the ambulance cover 100 may include navigation lights 400. In an embodiment, the navigation lights 400 may include two white headlights and/or red and green navigation lights, for example. In one or more embodiments, the navigation lights 400 may be USB chargeable, have a built-in battery, have a waterproof rate IPX5, and/or have an irradiation distance of 300 to 500 meters; however, the present disclosure is not limited thereto.

FIGS. 4E to 4L show various configurations of a dry bag 500, such as a dry bag that is compatible with Moves Patient Monitoring Systems, but the present disclosure is not limited thereto.

While the present disclosure has been described with particular references to some example embodiments thereof, the embodiments described herein are not intended to be exhaustive or to limit the scope of the invention to the exact forms disclosed. Persons skilled in the art and technology to which this invention pertains will appreciate that alterations and changes in the described systems and methods of operation can be practiced without meaningfully departing from the principles, spirit, and scope of this invention, as set forth in the claims, and equivalents thereof.

What is claimed is:

1. 1. An ambulance cover for an unmanned surface vehicle, the ambulance cover comprising:
a lid configured to be mounted on an unmanned surface vehicle; and
a seat mountable on the lid,
wherein the ambulance cover is configured to secure any of one or more stretchers at attachment points of the ambulance cover.

2. The ambulance cover of claim 1, wherein the unmanned surface vehicle is configured to operate autonomously.

3. The ambulance cover of claim 1, wherein the one or more stretchers include any of a plurality of different stretchers.

4. The ambulance cover of claim 1, further comprising one or more watertight dry storage compartments.

5. The ambulance cover of claim 4, wherein the one or more watertight dry storage compartments comprise a plurality of watertight dry storage compartments.

6. The ambulance cover of claim 4, further comprising at least one of a life vest, paddles, a blanket, a fire extinguisher, a whistle, and an air horn in the one or more watertight dry storage compartments.

7. The ambulance cover of claim 1, further comprising navigation lights.

8. The ambulance cover of claim 1, further comprising a patient hood.

9. The ambulance cover of claim 1, further comprising crane attachment slots.

10. The ambulance cover of claim 1, further comprising collapsible poles that are insertable through sleeves of the unmanned surface vehicle.

11. The ambulance cover of claim 1, further comprising carabiner clips to be secured to the unmanned surface vehicle.

12. A method of assembling an ambulance cover for an unmanned surface vehicle, the method comprising:
mounting a lid on an unmanned surface vehicle;
mounting a seat on the lid; and
securing a stretcher at attachment points of the ambulance cover.

13. The method of claim 12, wherein mounting the lid comprises securing the lid with rubber straps.

14. The method of claim 12, further comprising securing the ambulance cover to the unmanned surface vehicle with carabiner clips.

15. The method of claim 12, further comprising releasing pontons of the ambulance cover.

16. The method of claim 12, further comprising inserting poles of the ambulance cover through sleeves of the unmanned surface vehicle.
